(19) United States
(12) Patent Application Publication
(10) Pub. No.: US 2012/0278189 A1
(43) Pub. Date: Nov. 1, 2012

(54) DIGITAL CURRENCY CARD SALE, REDEMPTION AND ACTIVATION SYSTEM AND METHOD

(75) Inventors: Robert H. Goldberg, Santa Monica, CA (US); Jeffrey M. Mickeal, Encino, CA (US)

(73) Assignee: GMG Lifestyle Entertainment, Inc., Santa Clara, CA (US)

(21) Appl. No.: 13/446,906

(22) Filed: Apr. 13, 2012

Related U.S. Application Data
(60) Provisional application No. 61/475,136, filed on Apr. 13, 2011.

(51) Int. Cl. G06Q 20/20

(52) U.S. Cl. 705/17

(57) ABSTRACT

A system and method that facilitates an activation/redemption process for a digital currency card (DCC), e-PINs and bulk PIN activations/redemptions are disclosed. In the method, a sale process, an online user action with a PIN process and the simultaneous activation and redemption process occur. During this process the DCC is simultaneously activated and redeemed and the customer receives the face-value of the DCC for the stated virtual goods or currency from that redeeming company.

### PRIORITY CLAIMS/RELATED APPLICATIONS

This application claims the benefit under 35 USC 119(e) and 120 to U.S. Provisional Patent Application Ser. No. 61/475,136 filed on Apr. 13, 2011 and titled “Digital Currency Card Sale, Redemption And Activation System And Method”, the entirety of which is incorporated herein by reference.

### APPENDICES

Appendix A (14 pages) is an interface specification of the GMG Pulse Activation API that may be used in an implementation of the Digital Currency Card (DCC) sale, redemption and activation system. Appendix B (12 pages) is an interface specification of the GMG Pulse Redemption API that may be used in an implementation of the DCC sale, redemption and activation system. Both Appendix A and Appendix B form part of the specification.

### FIELD

The disclosure relates generally to an electronic currency system and in particular to a digital currency card sale, redemption and activation system and method.

### BACKGROUND

Today, a retailer is required to invest significantly in technical and other resources in their Point Of Sale (POS) internal systems to allow the current Point Of Sale Activation (POSA) Digital Currency Card (DCC) systems to work. The POSA process needs both a financial transaction processor and an activation company. The POSA prepaid card systems generally require deep and complicated integration into a retailer's POS systems. Under the POSA prepaid card systems, the physical cards are unique to each retailer which creates inefficiencies in managing card inventory across multiple retailers. In addition, at the register, the current POSA process requires a two-swipe or bar code process in which the first swipe or bar code scan is to buy the pre-paid card and the second swipe or bar code scan is to activate the DCC.

It is desirable to provide a DCC activation and redemption system that eliminates the need for the retailer to do any significant modifications to their existing POS internal systems and removes the requirement for a separate activation intermediary that is integrated into the retailer's POS. It is desirable to create a sale, redemption and activation process that utilizes the same card inventory across multiple retailers. It is also desirable to implement a one or two swipe or bar code scan DCC sale, redemption and activation process. Thus, it is desirable to provide a digital currency card sale, redemption and activation system and method that achieves these goals and it is to this end that the disclosure is directed.

### BRIEF DESCRIPTION OF THE DRAWINGS

FIG. 1 illustrates an example of an embodiment of a DCC sale, redemption and activation system;

FIG. 2 illustrates a method for DCC sale, redemption and activation that can be implemented using the DCC sale, redemption and activation system;

FIG. 3 illustrates an implementation of a saleable hosting and infrastructure system for the DCC sale, redemption and activation system;

FIG. 4 illustrates more detail of an implementation of the DCC system shown in FIG. 1;

FIG. 5 illustrates a DCC system flow for a use case of a first embodiment of the DCC sale, redemption and activation system;

FIG. 6 illustrates a DCC redemption flow for the first embodiment of the DCC sale redemption and activation system;

FIG. 7 illustrates a DCC system flow for a use case of a second embodiment of the DCC sale, redemption and activation system;

FIG. 8 illustrates a DCC redemption flow for the second embodiment of the DCC sale redemption and activation system; and

FIG. 9 illustrates an example of the database schema for a database that supports the DCC system.

### DETAILED DESCRIPTION OF ONE OR MORE EMBODIMENTS

The disclosure is particularly applicable to a web-based system for activation and redeeming digital currency cards and it is in this context that the disclosure will be described. It will be appreciated, however, that the system and method has greater utility since it can be implemented in other manners that are within the scope of the disclosure and may also be used for other cards or devices in which activation and then redemption occurs.

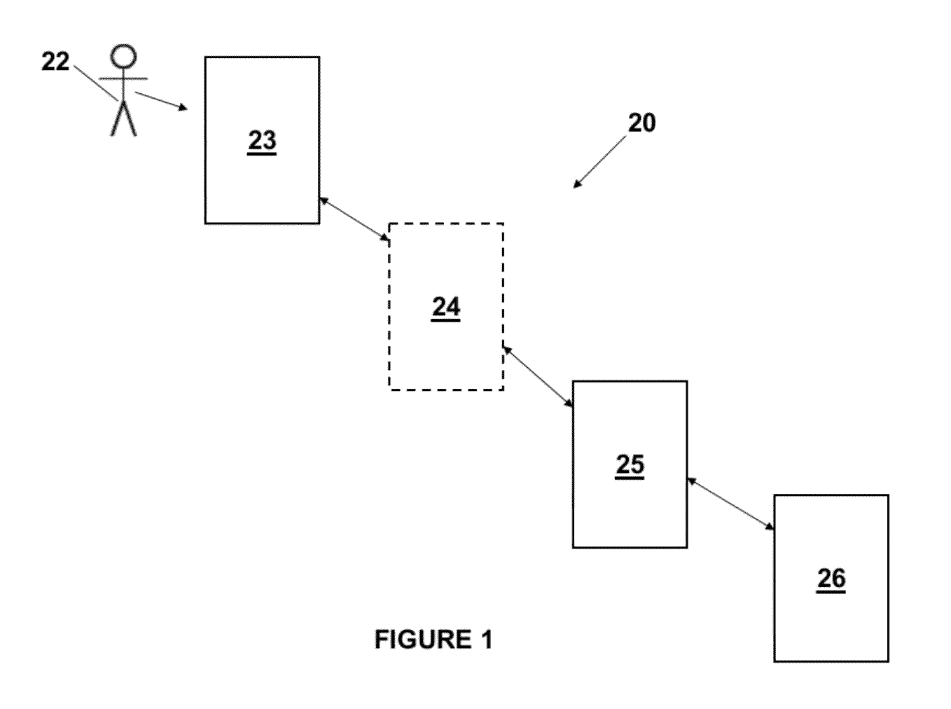

FIG. 1 illustrates an example of an embodiment of a DCC sale, redemption and activation system 25 that may be part of a prepaid card system 20. The system 25 allows a retailer system 23, such as a point of sale (POS) system, which is interacting with a customer/user 22 to sell, at the POS system, a DCC or other pre-paid cards. The system eliminates the need for the retailer 23 to do any significant modifications to their existing POS systems (as normally required in order to be able to activate and redeem stored value cards) and removes the requirement for a separate activation intermediary as is required with typical systems. In addition, the system 25 requires a one or two-swipe or bar code scan process for the consumer/user to buy the pre-paid card as described below in more detail. The system also permits a direct business relationship between the redeeming company and the retailer reducing the technical complexities of the point of sale activation system while streamlining the business economics. The system 25 also increases the available product offerings to the retailers since it removes the requirement of an activation intermediary and allows any redeeming company to use the system 25 to get access directly to the retailer. However, all retailers already have some sort of payment processing in place, either internal or external. For example, $20 may purchase 200 Facebook™ Credits on www.facebook.com or Facebook, a digital currency to be used in the game Sorority Life™ on Facebook™. These Facebook™ Credits are used to purchase virtual clothing, virtual accessories, virtual transportation and other items to be used in that game. Similar types of virtual items and virtual land can be purchased using points or scrip in other games, such as Farmville™, Mafia Wars™, Tiki Land™ and other games in the Facebook™ space.

The system 25 may be used to activate and redeem a DCC (the details of the process are described below). Each DCC that is activated and redeemed using the system may have a magnetic strip or an embedded chip and may also have a personal identification number (PIN) associated with the card. The PIN may be located on the card (covered by a scratch off portion), may be on a register receipt tape when the card is purchased and/or may be digitally delivered PIN, such as an e-PIN. In one implementation, the owner of the system 25 may manufacture and distribute branded DCCs. The system 25 also may be used with virtual gift cards that have e-PINS or anything that is redeemable online in ecommerce (iTunes DCC, Facebook DCC, etc.) where the user must enter a PIN as part of the validation/activation/redemption process in order to use the value of the card. In the system 20 shown in FIG. 1, known security protocols are used to ensure that the data transmitted between the DCC system 25 and the other systems is secure. For example, the communications between redeeming company systems 26 and the DCC system 25 may take place over HTTPS, using a set of REST-like web-services. In addition, whitelisted IP addresses (the DCC system 25 is only accessible from a specific list of IP addresses) and “secret keys” with each redeeming company system are used to ensure requests from the digital partners are authorized. In one implementation, each redeeming company is assigned one set of API Key/API Secret per environment (typically one set for stage environment and one for production environment) and all requests from each redeeming company to the DCC system 25 contain the partner API Key and are signed with the API Secret which allows the DCC system 25 to uniquely identify the redeeming company making the request and prevent the request parameters from being tampered with.

In addition to the retailer 23, the system 20 may also include a DCC system 25 that performs the activation and redemption of the pre-paid card as described below in more detail and a redeeming company 26 at which the DCC is spent by the consumer/user as described below in more detail. In a different embodiment, the system 20 may also include a processor system 24 (shown in phantom since the system 20 can be implemented without the processor 24) that processes the financial transactions as described below for one embodiment of the system.

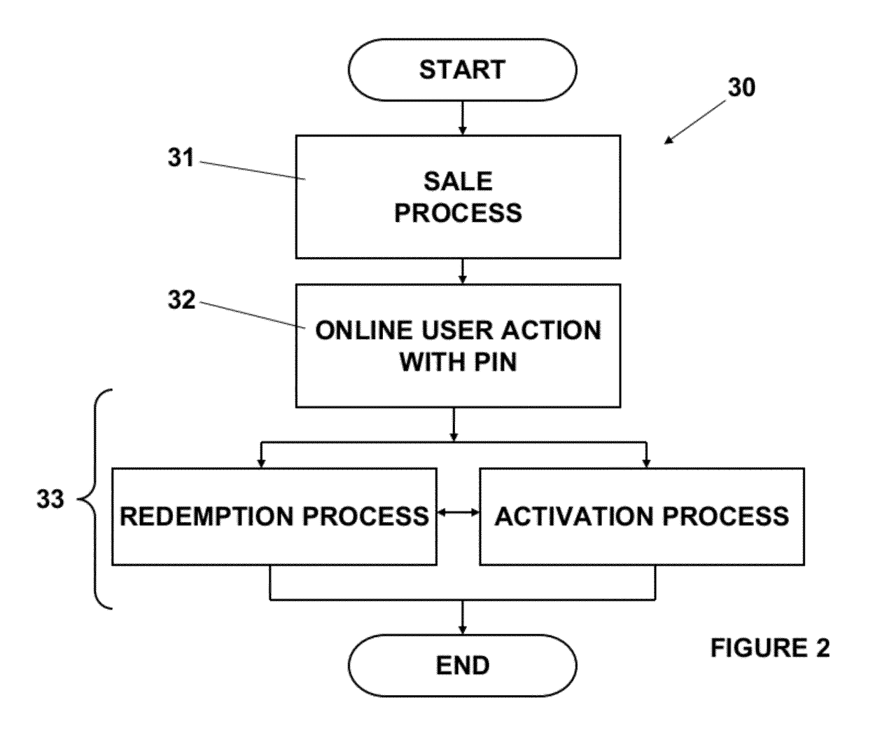

FIG. 2 illustrates a method 30 for DCC sale, redemption and activation that can be implemented using the DCC sale, redemption and activation system 25. The system 25 performs a three stage sale, activation and redemption process for DCCs through and in conjunction with the application programming interfaces (APIs) of the system 25. The method involves a sale process 31, an online end-user action with a PIN process 32 and a simultaneous activation and redemption process 33 as shown in FIG. 2. The sale process 31 occurs when a customer, at a retail location, takes a pre-paid card to the check-out and purchases the card. During the sale process 31, the checker at the retail location swipes or scans the bar code on the card which sends a signal to the DCC system 25 that places this card in a sold state. During the online end-user action with a PIN process 32, the customer/user takes the card and keys in the PIN online based on the instructions on the back of the DCC and activates the PIN using a computing device that has at least a processing unit, memory and connectivity to interact with the redeeming company's site. Each computing device may be a personal computer, laptop computer, smartphone and the like. If the customer/user is a new user to the site, the consumer/user is required to create a new account based on that redeeming company's new user registration process. Following the PIN input, the redeeming company system 26, whose system is integrated directly with the APIs of the DCC system 25, transmits the PIN directly to DCC system 25 at which time the programmed procedures of the DCC system 25 determines the appropriate next step as described below in more detail. For example, if the card has been sold and the user enters his/her PIN, the status of the card in the DCC system 25 is changed to activated/redeemed and a message is sent back to the digital partner system 26 that the card is valid and the digital partner credits that user's account with the face value of that card in their assigned account.

During the simultaneous activation and redemption process 33, that occurs from the user's actions with the PIN, the customer effectively redeems the face-value of the DCC for the stated virtual goods or currency from that redeeming company. The DCC system 25 also logs the activation/redemption data for the card. In addition, on a daily basis, the DCC system 25 generates detailed sales reports and activation/redemption reports at the card level with a one-day delay and these files are available for the redeeming company to ingest. Each digital partner system 26 has access to a secure online reporting tool, GMG Pulse, where they can review sales and activation/redemption trends.

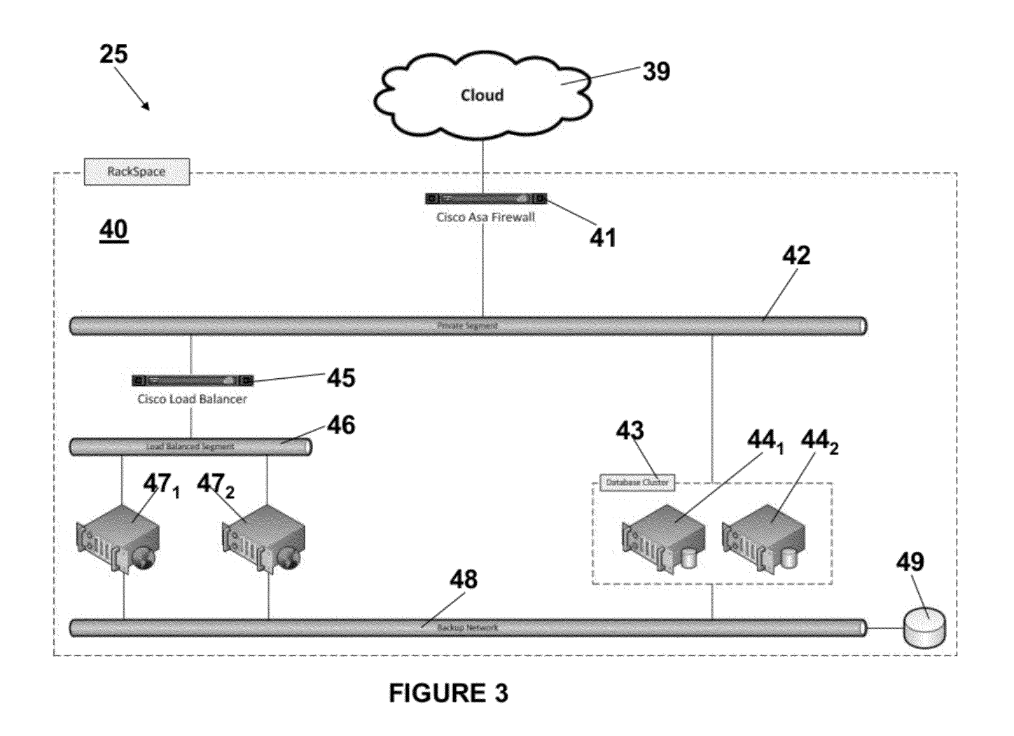

FIG. 3 illustrates an implementation of a hosting system for the DCC sale redemption and activation system 25 in which the system may be hosted at a hosting site 40, such as Rackspace, and then connected to a network 39, such as the cloud, by a firewall 41 which is then connected to a private segment 42 as shown. The private segment 42 may be connected to a database cluster 43 (that may include one or more database servers 44₁, 44₂, for example) and to a load balancer 46 that creates a load balanced segment 46 which is in turn connected to one or more application servers 47₁, 47₂ for example. The database cluster 43 and the one or more application servers 47₁ and one or more web servers 47₂ are in turn connected to a backup network 48 which is also connected to a database 49. In one implementation, the system 25 may be implemented in a plurality of lines of computer code that may be executed by the servers in FIG. 3 wherein the computer code may be written in .NET 4.0/C#/MS SQL 2008 running on Windows Server 2008. In one implementation, the servers may be Dual Core Xeon 2.33 Ghz, 4GB RAM (2×) and each database server may be a Quad Core XEON 2.5 Ghz, 16GB RAM (2×, Active/Passive failover cluster).

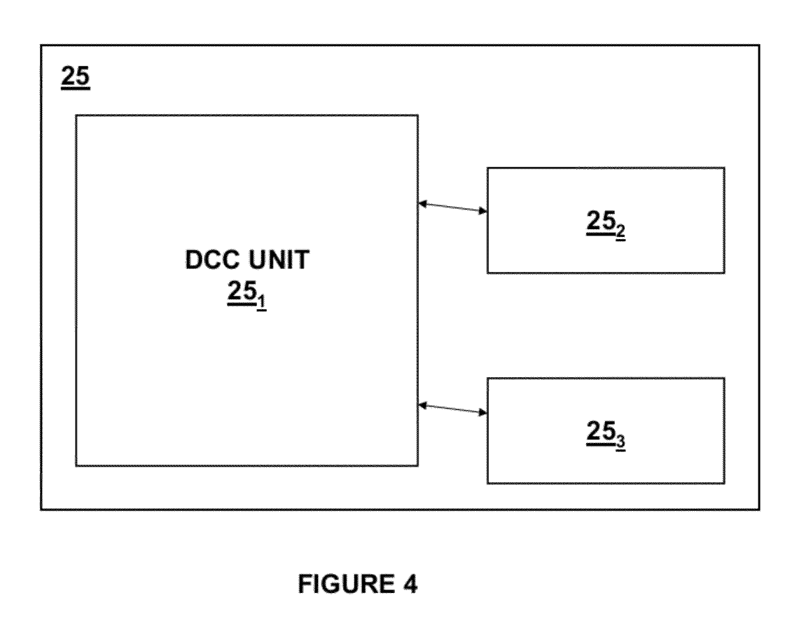

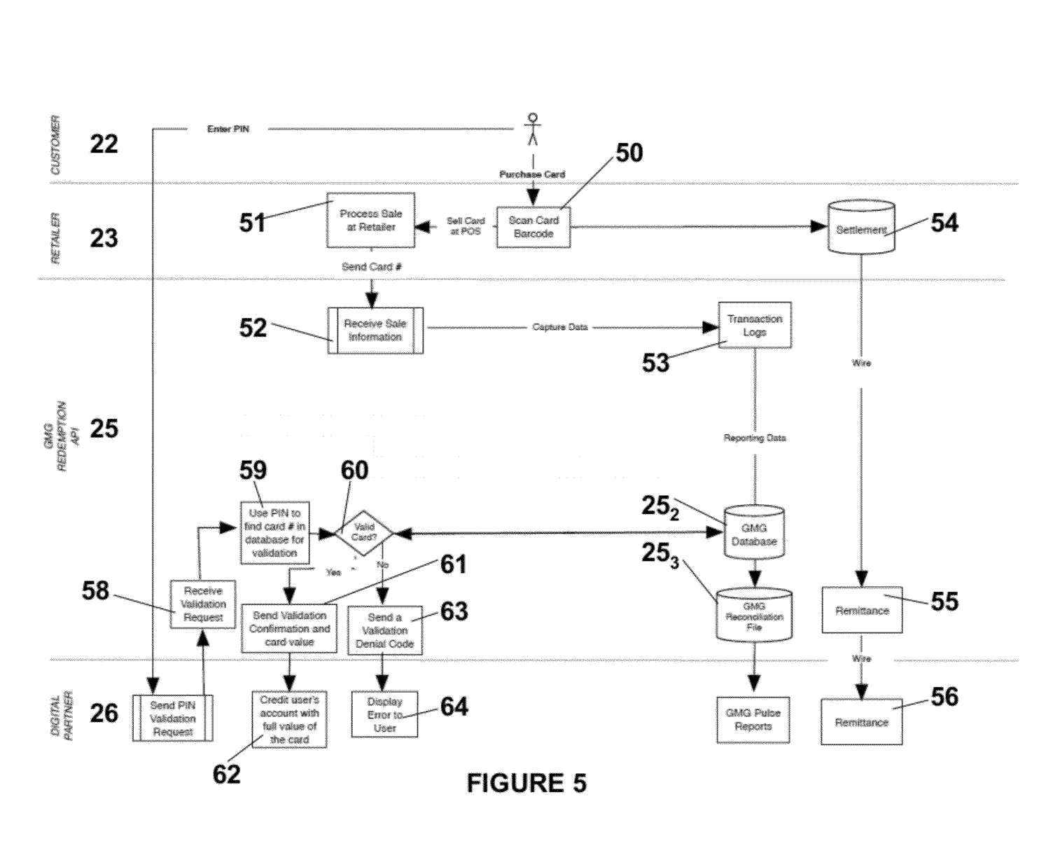

FIG. 4 illustrates more detail of an implementation of the DCC system 25 shown in FIG. 1. As described above, the elements shown in FIG. 4 may be implemented in a plurality of lines of computer code that are executed by one or more computer systems with one or more processors, memory and other well known components of computer systems. Alternatively, the DCC system 25 can be implemented using programmed hardware systems. In addition, the DCC system 25 has a client/server type architecture (with the web servers), but the DCC system 25 may also be implemented using other known computer system architectures that are within the scope of the disclosure. As shown in FIG. 4, the system 25 may include a DCC unit 25₁ and one or more storage units. The DCC unit 25₁ performs the activation and redemption processes shown in FIGS. 5-8 that are described below in detail. In one implementation, the DCC unit 25₁ has a plurality of lines of computer code that are executed by a processing unit of the DCC system 25 to implement the activation and redemption processes. The one or more storage units may be a DCC database 25₂ and a reconciliation storage 25₃ from which reports and the like can be generated as described below.

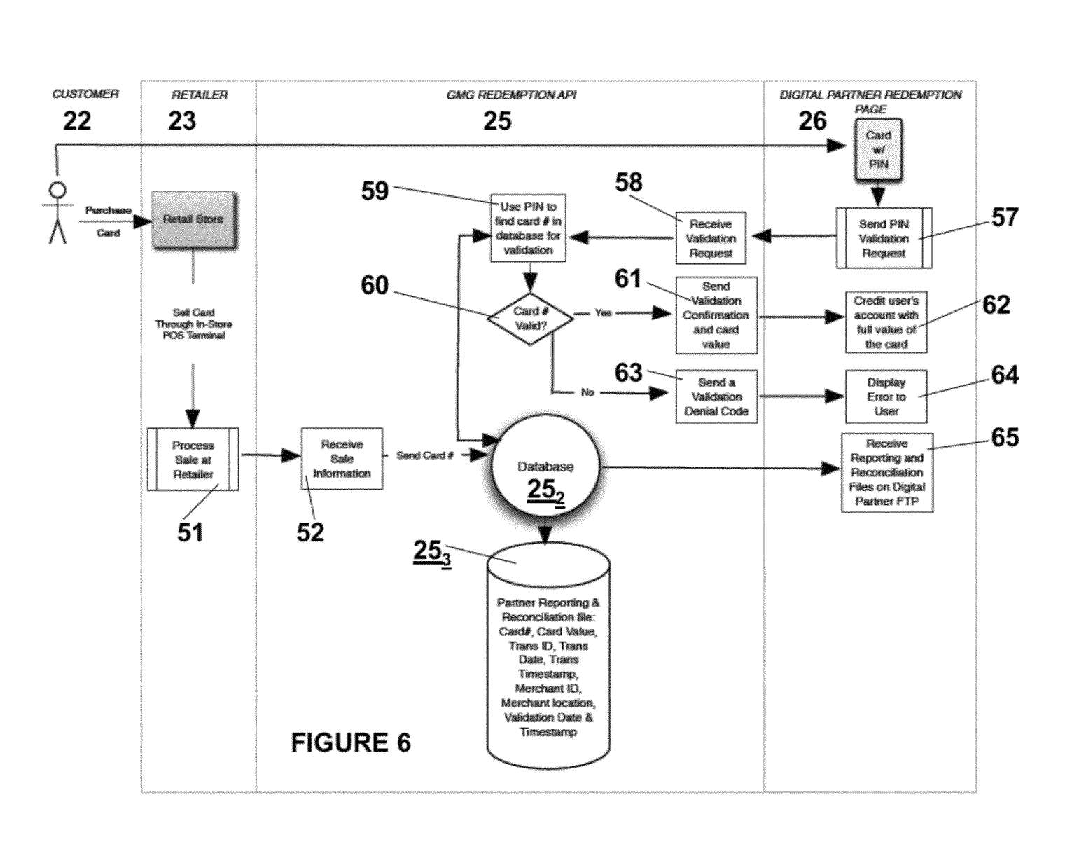

FIGS. 5 and 6 illustrates a DCC system flow for a use case of a first embodiment of the DCC sale redemption and activation system with the customer 22, the retailer system 23, the DCC system 25 and the redeeming company system 26. In the process of this embodiment, a customer at retail takes a prepaid card to the checkout at the retail location 23 and purchases the card. The checker at the retail location 23 swipes or scans the bar code of the card 50 at a point of sale unit at the retailer and the retailer processes the sale 51. When the retailer processes the sale, the sale may also go to a settlement system 54 of the retailer that communicates with a remittance unit 55 of the DCC system 25 (by wire in one implementation) and then the remittance unit 55 of the DCC system 25 communicates (by wire in one implementation) with a remittance unit 56 of the redeeming company 26.

The retailer then sends the card number of the card sold to the DCC system 25. The DCC system 25 receives the card number and sale information 52 to be stored in a data log/transaction log 53 of the DCC system 25 for use during the validation/activation/redemption process. The data from the transaction logs in the form of reporting data (as well as other reporting data) are then stored in the database 25₂ and then into the reconciliation file 25₃ so that the Pulse reports can be generated that are available to each redeeming company system 26.

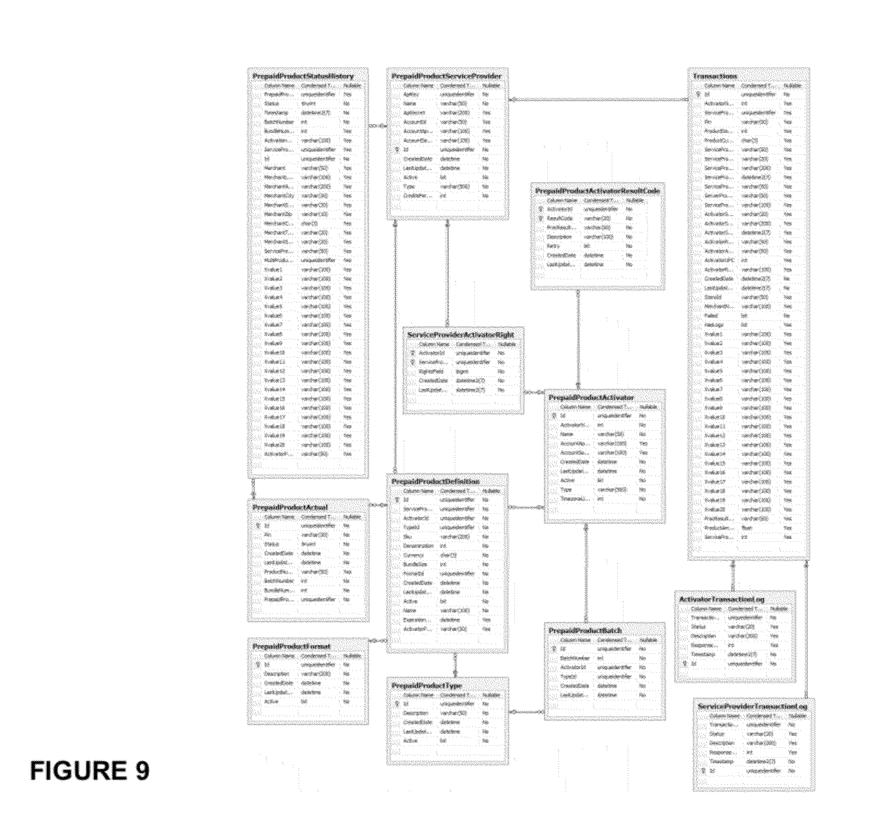

The reconciliation file 25₃ as shown in FIG. 6 may include the following information for each prepaid card: the card number, the card value, a transaction ID, transaction time and transaction timestamp for purchasing the card, a merchant identifier and merchant location for the retailer, a validation date when the prepaid card is validated and a timestamp for the validation. In one implementation, the reconciliation file may have the following data fields: Merchant [string(50)] which contains the name of the merchant where the product was sold; Location [string(20)] which contains the merchant location of where the product was sold; City [string(30)] which contains the name of the city the merchant location is in; State [string(30)] which contains the name of the state the city is in; Zip [string(10)] which contains the zip code tied to the merchant location; Country [char(3)] which contains the country where the product was sold; Vendor [string(50)] which contains the name of the vendor(service provider) for the product; Vendor ID[string(50)] which contains an identifier of the vendor; STOREID [string(20)] which contains the merchant store id for the location; Product [string(200)] which contains the SKU for the product that was sold; Denomination [32 Bit Integer] which contains the value of the product that was sold; SerialNumber [string(50)] which contains the product number tied to the product sold; GMG16 [string(50)]; TransDate [DateTime MM/dd/yyyy] which contains the date the sale took place; TransTime [DateTime HH:mm:ss] which contains the time the sale took place; Action [char(1)] which contains the action of the transaction, ‘A’—Sold, ‘D’—Deactivate, ‘S’—Suspend; Sign [32Bit Integer] which contains the sign of the request (+/−)1, Activate is 1, all others are −1; CardAmount [Decimal] which contains the amount the product was sold for ((denomination*100)*sign); and RefNo [Guid] which contains the Id tied to the status history event of the sales transaction. FIG. 9 illustrates an example of the database schema for a database that supports the DCC system in one implementation of the DCC system.

During the PIN activation, the user 22 enters a PIN of the prepaid card and communicates the PIN to a system of the redeeming company 26 (such as using a website of the redeeming company, an app of the redeeming company and the like). When the redeeming company receives the PIN, the redeeming company sends a PIN verification request (57) which is received by the DCC system 25 (58). The DCC unit 25₁ uses the PIN to find the prepaid card number in the database 25₂ for validation (59) to determine if the prepaid card and the PIN are valid (60) and determines the value of the prepaid card. If the card and PIN are valid, the DCC unit 25₁ sends a validation confirmation and card value message (61) back to the redeeming company 26 and the redeeming company credits the user's account with the value of the prepaid card (62). If the card and PIN are not valid, the DCC unit sends a validation denial code (63) to the redeeming company who then displays an error message/denial message to the user (64). In this manner, the user can purchase a DCC at a retailer, activate and redeem the prepaid card and then use the DCC at the redeeming company using the DCC system 25.

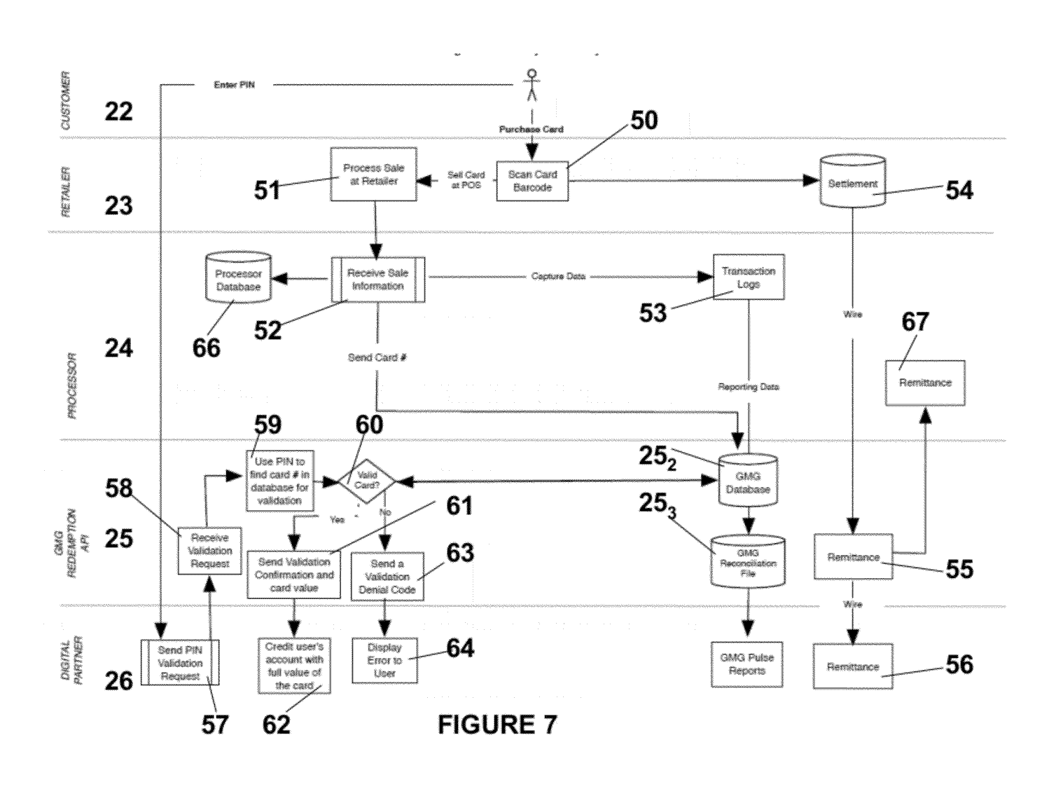

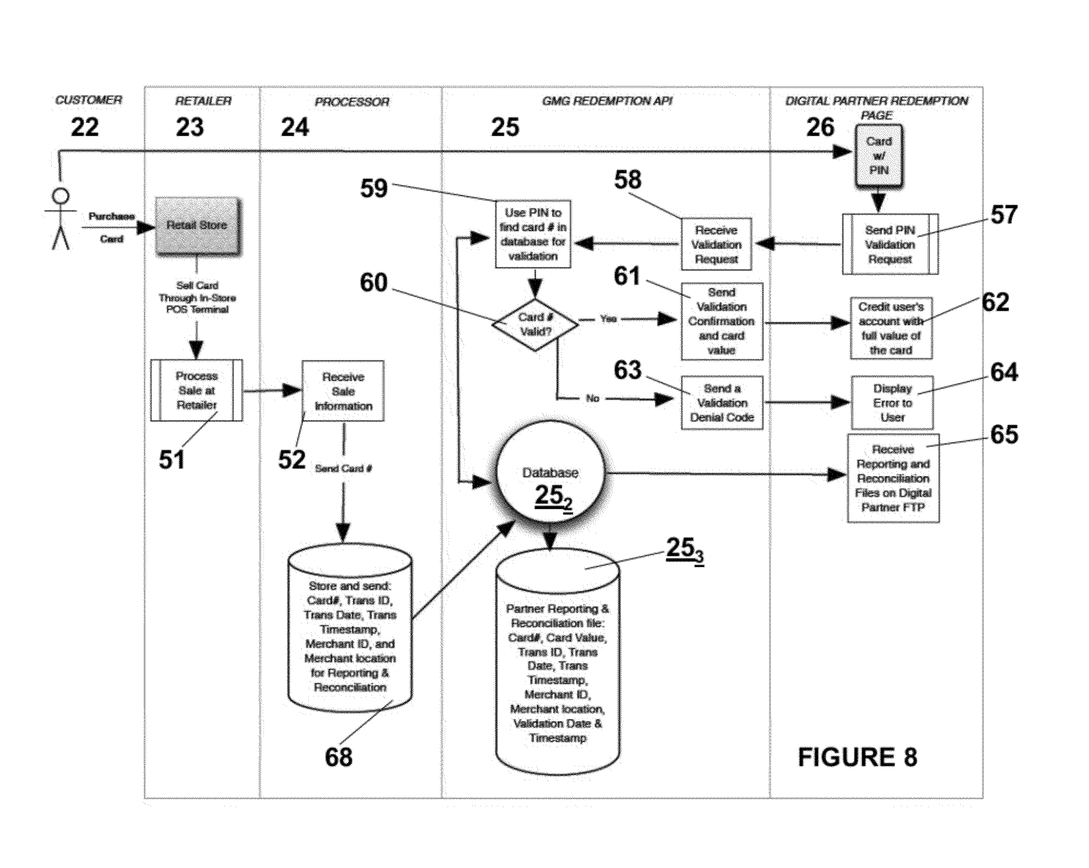

FIGS. 7 and 8 illustrate a DCC system flow for a use case of a second embodiment of the DCC point-of-sale redemption and activation system that includes a processor(s) system 24. In this process, a customer at retail 23 takes a prepaid card to the checkout and purchases the card. The checker at the retailer swipes or scans the bar code of the card to process the sale (51), which sends a signal to the processer(s) system 24 (e.g. First Data Corporation) that the card has been sold which is received by the processor(s) (52). The processor 24 stores the sale information in a processor database 66 and sends the card # of the card sold as a transaction log 53 to the DCC system 25 to be stored in the DCC store 25₂ for use during the validation/activation/redemption process. The remittance processes and redemption processes are similar to the embodiment shown in FIGS. 5-6 above except that the processor also has a remittance database 67 into which the remittance data is written.

During the activation/redemption, once the customer has purchased the DCC, the customer follows the redemption instructions on the back of the redeeming company's DCC. If the user has an account with this redeeming company, he/she goes to the destination url stated on the DCC, logs into the site, scratches off the foil on the back of the card, keys in the PIN and submits it (when a scratch off PIN is used). If this user does not have an account with the digital partner, the redeeming company will have the user complete a registration process prior to redemption. Once the user submits the PIN, the redeeming company then sends the PIN to the DCC system 25 to validate the card and PIN using the same process described above.

In addition to the prepaid cards described above, the above activation and redemption processes and system may be used with online sales of stored values in which the PIN may be digitally delivered to the customer and the same PIN activation, validation and redemption process can be carried out. In addition, a user/consumer can purchase a virtual gift card where the user/consumer receives the PIN digitally and the same PIN activation, validation and redemption process can be carried out. The system also may be used for a gifting purchase is which a user is able to purchase a virtual gift card and send it to someone, who then receives the PIN digitally and the same PIN activation, validation and redemption process can be carried out. The system also may be used for business to business bulk purchases in which a company buys a number of prepaid cards in bulk as an incentive program for their employees and then the prepaid cards are ready for validation/redemption as described above using the system. The system also may be used for bulk promotional cards in which promotional cards are bought in bulk for events or various other instances. These are a bulk “sale” and are ready for validation/activation/redemption as described above using the system. The system also may be used for bulk promotional PINs in which promotional PINs are bought in bulk for co-branded products (e.g. Coke under the cap, peel off, etc.) or various other instances. These are a bulk “sale” and are ready for validation/activation/redemption as described above using the system.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A prepaid card redemption and activation system, comprising:
a retailer with a point of sale system that is capable of reading a prepaid card by the point of sale system to indicate that a consumer has purchased the prepaid card, each prepaid card having a unique card identifier and personal identification number (PIN) associated with the prepaid card;
a computer based DCC unit, electronically coupled to the retailer point of sale system, that receives a card identifier of a prepaid card that was purchased using the point of sale system; and
wherein the computer based DCC unit receives a confirmation of the validity of the purchased prepaid card.

2. The system of claim 1 further comprising a redeeming company prepaid card system that receives a validation request for the purchased prepaid card from the consumer using a computing device and credits the account of the consumer with the value of the prepaid card when the prepaid card is validated.

3. The system of claim 2, wherein the computer based DCC unit is in a cloud.

4. The system of claim 2, wherein the prepaid card has a magnetic strip.

5. The system of claim 2, wherein the PIN is one of located on the prepaid card, located on a register tape from the purchase of the prepaid card and an ePIN.

6. The system of claim 2, wherein the DCC unit sets up an API key and API secret for each redeeming company to secure the communications between the redeeming company and the DCC unit.

7. The system of claim 2, wherein the point of sale system one of swipes and scans the prepaid card.

8. The system of claim 2, wherein the computing device is one of a personal computer, a laptop computer and a smartphone.

9. A method for prepaid card redemption and activation, comprising:
purchasing, at a retailer location, a prepaid card by reading the prepaid card by a point of sale system at the retailer location;
communicating, from the point of sale system at the retailer location to a computer based DCC unit, a card identifier of a prepaid card that was purchased using the point of sale system;
receiving, at redeeming company prepaid card system, a validation request for the purchased prepaid card from the consumer using a computing device; and
communicating, from the redeeming company prepaid card system to the DCC unit, a validation confirmation request.

10. The method of claim 9 further comprising crediting, at the redeeming company prepaid card system, the account of the consumer with the value of the prepaid card when the prepaid card is validated.

11. The method of claim 10, wherein the prepaid card has a magnetic strip.

12. The method of claim 10, wherein the PIN is one of located on the prepaid card, located on a register tape from the purchase of the prepaid card and an ePIN.

13. The method of claim 10 further comprising setting up, by the DCC unit, an API key and API secret for each redeeming company to secure the communications between the redeeming company and the DCC unit.

14. The method of claim 10, wherein purchasing the prepaid card further comprises one of swiping the prepaid card through the point of sale system and scanning the prepaid card through the point of sale system.

15. A prepaid card redemption and activation system, comprising:
a retailer with a point of sale system that is capable of reading a prepaid card by the point of sale system to indicate that a consumer has purchased the prepaid card, each prepaid card having a unique card identifier and personal identification number (PIN) associated with the prepaid card;
a transaction processor, electronically coupled to the retailer point of sale system, that receives prepaid sale information from the retailer with a point of sale system; and
a computer based DCC unit, electronically coupled to the transaction processor, that receives a card identifier of a prepaid card that was purchased using the point of sale system and receives confirmation of the validity of the purchased prepaid card by a redeeming company.

16. The system of claim 15 further comprising a redeeming company prepaid card system that receives a validation request for the purchased prepaid card from the consumer using a computing device and credits the account of the consumer with the value of the prepaid card when the prepaid card is validated.

17. The system of claim 16, wherein the computer based DCC unit is in a cloud.

18. The system of claim 16, wherein the prepaid card has a magnetic strip.

19. The system of claim 16, wherein the PIN is one of located on the prepaid card, located on a register tape from the purchase of the prepaid card and an ePIN.

20. The system of claim 16, wherein the DCC unit sets up an API key and API secret for each redeeming company to secure the communications between the redeeming company and the DCC unit.

21. The system of claim 16, wherein the point of sale system one of swipes and scans the prepaid card.

22. The system of claim 16, wherein the computing device is one of a personal computer, a laptop computer and a smartphone.

23. A method for prepaid card redemption and activation, comprising:
purchasing, at a retailer location, a prepaid card by reading the prepaid card by a point of sale system at the retailer location;
communicating, from the point of sale system at the retailer location to a transaction processor, a set of sales information about the sale of the prepaid card;
communicating, from the transaction processor to a computer based DCC unit, a card identifier of a prepaid card that was purchased using the point of sale system;
receiving, at redeeming company prepaid card system, a validation request for the purchased prepaid card from the consumer using a computing device; and
communicating, from the redeeming company prepaid card system to the DCC unit, a validation confirmation request.

24. The method of claim 23 further comprising crediting, at the redeeming company prepaid card system, the account of the consumer with the value of the prepaid card when the prepaid card is validated.

25. The method of claim 24, wherein the prepaid card has a magnetic strip.

26. The method of claim 24, wherein the PIN is one of located on the prepaid card, located on a register tape from the purchase of the prepaid card and an ePIN.

27. The method of claim 24 further comprising setting up, by the DCC unit, an API key and API secret for each redeeming company to secure the communications between the redeeming company and the DCC unit.

28. The method of claim 24, wherein purchasing the prepaid card further comprises one of swiping the prepaid card through the point of sale system and scanning the prepaid card through the point of sale system.
